(19) United States
(12) Patent Application Publication
(10) Pub. No.: US 2009/0192821 A9
(43) Pub. Date: Jul. 30, 2009

(54) Medical image annotation

(75) Inventors: Edward Park, Waltham, MA (US); Anshul Amar, Cambridge, MA (US)

Correspondence Address: PROSKAUER ROSE LLP, ONE INTERNATIONAL PLACE, BOSTON, MA, 02110, US

(73) Assignee: Athenahealth, Inc., Watertown, MA (US)

(21) Appl. No.: 11/514,469

(22) Filed: Sep. 1, 2006

(51) Int. Cl. G06F 19/00; G06Q 40/00

(52) U.S. Cl. 705/3; 705/4

(57) ABSTRACT

Incorporating new technology into an existing medical practice is often difficult. Documents associated with a patient, for example, a patient's medical charts, are typically provided physically, i.e., as “hard copies,” when a patient is being serviced by multiple health care providers Disclosed are means for electronically annotating an image associated with a patient workflow. In one implementation, there is a method that includes receiving an image via a communications network, presenting the image to a user, and capturing an annotation made to the image by the user. The annotations and the image to a medical practice management server via the communications network and the annotated image is stored as part of a patient medical record.

### FIELD OF THE INVENTION

The present invention relates generally to medical patient workflow and more specifically to annotating an image as part of a medical patient workflow.

### BACKGROUND

Before the advent of networked systems and computers, medical patient workflow and billing was a manual process. Doctors, nurses, receptionists, and others used paper-based records to keep track of what procedures a patient had undergone, what the patient's insurance would and would not cover, and how claims for procedures were to be settled. As computers became more prevalent and widely utilized, many medical practitioners used computers for electronic record keeping and billing statement generation. To fill this niche, many companies began providing software to assist medical practitioners with managing their medical practice. The software and systems provided, however, typically solved only a particular problem, e.g., one company's software focused on billing automation, while another company's software focused on patient management.

Additionally, integrating new technology with a health provider's existing practice often proves to be a challenge. For example, whereas documents associated with a patient, e.g., a patient's medical charts, were previously provided physically, i.e., as “hard copies,” between health care providers, e.g., family practitioner to a hospital, now many patient's documents, charts, and medical history are available electronically. Typically charts are provided as images or facsimile (fax) documents. Many medical providers, however, lack the ability to integrate these documents into their existing practice workflow and patient records. Rather, the electronic documents are received and printed out for the health care provider, the electronic aspect simply replacing the means through which the documents are conveyed rather than the documents themselves.

In addition to the difficulties encountered when sharing documents, it is sometimes unmanageable to coordinate communication and workflows between medical care providers, especially when the health care providers are not part of the same network. For example, a specialist health care provider that is a member of Blue Cross/Blue Shield of Massachusetts may encounter difficulty treating a patient whose primary care physician is a member of only Harvard Pilgrim medical group because there is no means of communicating securely about the patient's care. A similar problem is presented when medical care providers use different automated workflow and billing systems associated with a medical practice; typically a medical provider using one system cannot communicate with the other health care provider or modify the second health care provider's system, e.g., when the patient has an operation performed.

### SUMMARY

In one aspect there is a method for electronically annotating an image associated with a medical patient workflow. The method includes receiving the image via a communications network, optionally via a facsimile machine. The image is presented, typically via a web browser, to a user associated with the patient workflow. Annotations made by the user are captured, typically via a plug-in to a web browser. Capturing annotations typically involves receiving an electronic signal corresponding to a location of a pixel of the image. The annotation can be edits to the image such as keystrokes received from a keyboard or movements received from a pointing device such as a digital pen or a mouse.

The method, in some implementations, further includes transmitting the annotated image via the communications network to a medical practice management server and storing the annotated image as part of a patient medical record. Additionally or alternatively, the annotated image is submitted to the medical patient workflow. In some implementations the method further includes transmitting the annotated image from the medical practice management server to another party such as who the image was received from or an insurance company/payor.

In some embodiments, there is a computer program product, tangibly embodied in an information carrier, for electronically annotating an image associated with a patient workflow. The computer program product, e.g., software, including instructions that are operable to cause a data processing apparatus, such as a computer, to receive the image, present the image to a user associated with the patient workflow, and capture an annotation made to the image by the user. The image is received and transmitted over the communications network, the often between a web browser and a medical practice management server. The image and/or annotations may also be received/transmitted over the communications network via a facsimile (fax), e.g., the medical practice management server receives a fax document and transmits the document (or an image that was created based on the faxed document) to the web browser or the web browser saves annotations to the medical practice management server, which in turn transmits the annotated image to a recipient via fax machine. Further the image, along with any annotations made, is stored as part of a patient medical record, e.g., in a patient information database. In some versions, the software, during execution by a computer, also submits the annotated image to the medical patient workflow.

There is also a system for electronically annotating an image associated with a patient workflow. The system includes a server and a client. The server is a medical practice management server, configured to receive the image and transmit the image over a communications network, in some embodiments via a fax machine. The client software program, usually a web browser or a plug-in to a web browser, is configured to receive the image from the server, further configured to capture an annotation to the image made by a user, and further configured to transmit the image and the annotation to the image to the server. The server is further configured to store the image as part of a medical patient medical record.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 depicts a block diagram of an implementation of a medical practice management system that includes a medical practice client computer, a medical practice management server, and a payor server computer;

FIG. 2A depicts a block diagram of an implementation of the medical practice management server that includes a workflow processing engine, a rules engine, and an intelligent transactions relationship (ITR) module;

FIG. 2B depicts a block diagram of an implementation of the rules engine interacting with several payors including a first payor, a second payor, and a third payor 105;

FIG. 3 is a block diagram depicting a method for electronically annotating an image associated with a patient workflow; and

FIG. 4 is a diagram depicting an embodiment wherein a web browser includes a plug-in to present an image to the user for annotation.

### DETAILED DESCRIPTION

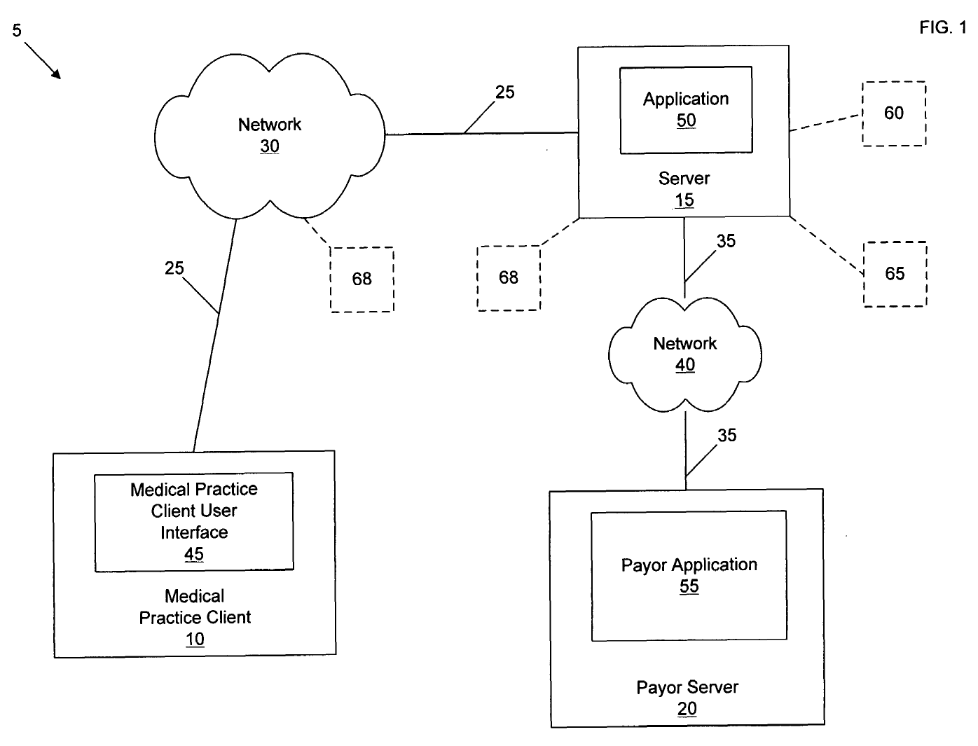

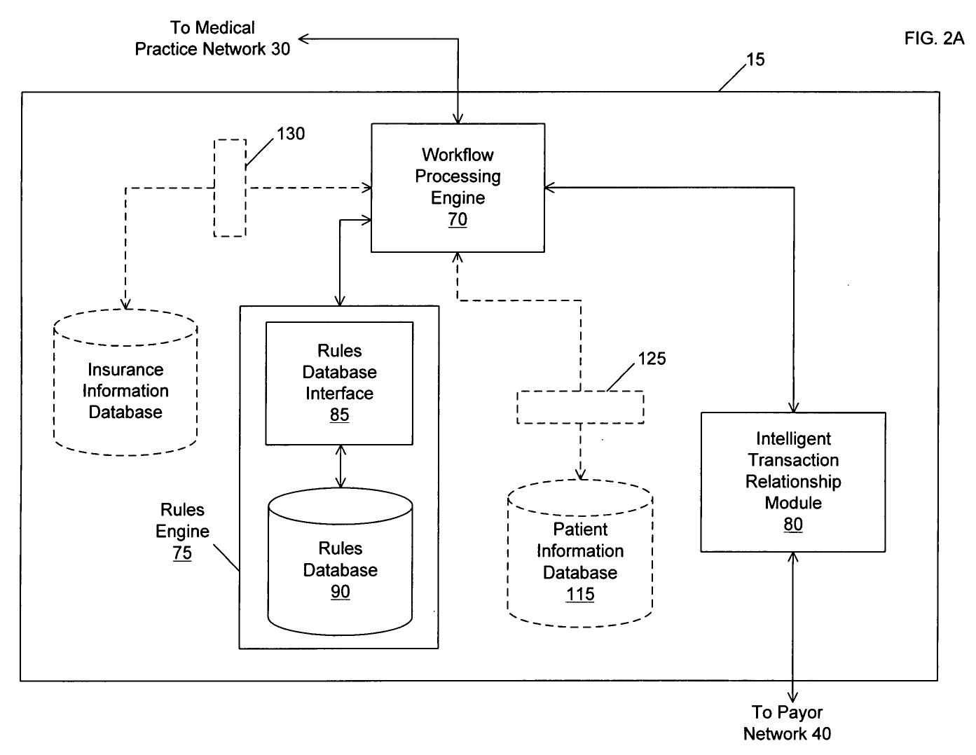

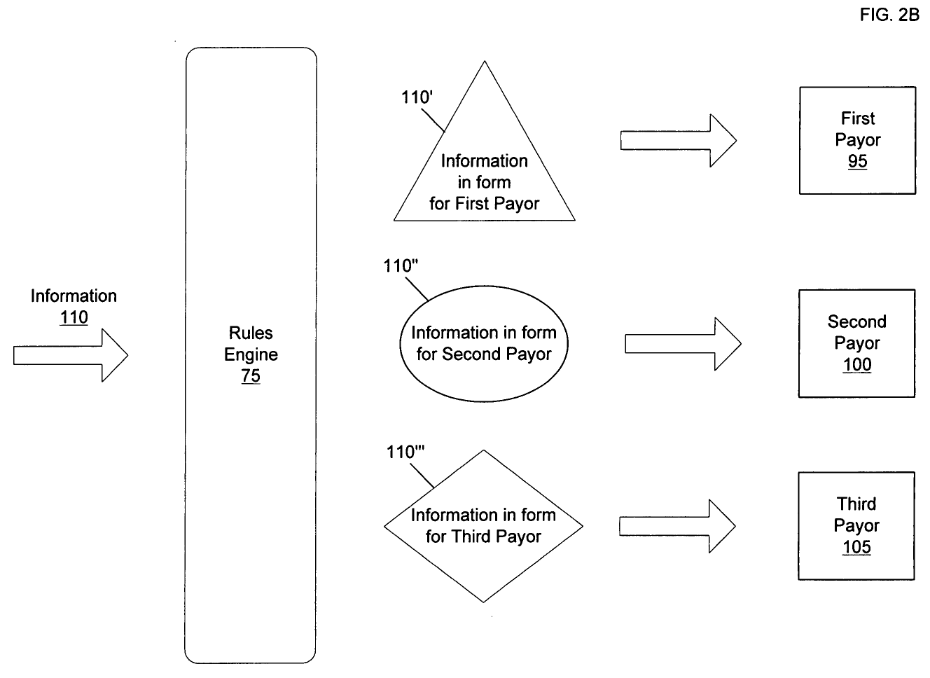

Automating medical practice workflow and billing presents difficulties in many aspects, e.g., installation of a system, processing the eligibility or other statuses of patients, interacting with the workflow, other health care providers, and within the constraints of payor requirements, as well as measuring the success of a practice once it has been established. The invention encompasses several aspects, embodied in varying implementations that address these shortcomings. FIGS. 1, 2A, and 2B and the accompanying description provide an example of one implementation of an architecture in which aspects of the invention operate.

FIG. 1 depicts a block diagram of an implementation of a medical practice management system 5 that includes a medical practice client computer (or medical practice client) 10, a medical practice management server (or server) 15, and a payor server computer (or payor server) 20. The medical practice client 10 is in communication with the medical practice management server 15 over a medical practice client-server communication path 25 and passes through a first communications network (or medical practice client-server network) 30. The medical practice management server 15 is also in communication with the payor server 20 over a payor server communication path 35 and passes through a second communications network (or payor server network) 40. FIG. 1 is an exemplary embodiment intended only to illustrate one implementation of a general architecture of, and not to limit, the invention.

The medical practice client-server network 30 and the payor server network 40 can be a local-area network (LAN), a medium-area network (MAN), or a wide area network (WAN) such as the Internet or the World Wide Web. In one embodiment, the medical practice client-server network 30 (e.g., the medical practice client-server communication path 25) supports secure communications. In a further embodiment, communications occur after a medical care provider's, or user's, password is verified by the medical practice management server 15. Exemplary embodiments of the communication paths 25, 35 include standard telephone lines, LAN or WAN links (e.g., T1, T3, 56 kb, X25), broadband connections (e.g., ISDN, Frame Relay, ATM), and wireless connections. The connections over the communication paths 25, 35 can be established using a variety of communication protocols (e.g., TCP/IP, IPX, SPX, NetBIOS, Ethernet, RS232, and direct asynchronous connections).

The medical practice client 10 can be any personal computer, Windows-based terminal, network computer, wireless device, information appliance, RISC Power PC, X-device, workstation, mini computer, main frame computer, personal digital assistant, or other computing device that has a windows-based desktop, can connect to a network and has sufficient persistent storage for executing a small, display presentation program. Windows-oriented platforms supported by the medical practice client 10 can include, without limitation, Windows 3.X, Windows 95, Windows 98, Windows NT 3.51, Windows NT 4.0, Windows 2000, Windows XP, Windows Vista, Windows CE, Windows Mobile, Mac/OS, OS X, Java, and Unix/Linux. The medical practice client 10 can include a visual display device (e.g., a computer monitor), a data entry device (e.g., a keyboard), persistent or volatile storage (e.g., computer memory) for storing downloaded application programs, a processor, and a pointing device such as a mouse or digitized pen.

The medical practice client 10 includes a medical practice client user interface 45. The interface 45 can be text driven (e.g., DOS) or graphically driven (e.g., Windows). In one embodiment, the medical practice client user interface 45 is a web browser, such as Internet Explorer™ developed by Microsoft Corporation (Redmond, Wash.), to connect to the medical practice client-server network 30. In a further embodiment, the web browser uses the existing Secure Socket Layer (SSL) support, developed by Netscape Corporation, (Mountain View, Calif.) to establish the medical practice client-server network 30 as a secure network.

The medical practice management server 15 and the payor server 20 can be any personal computer. In one embodiment, the medical practice management server 15 hosts one or more applications 50 that the medical practice client 10 can access. Moreover, the payor server 15 can host one or more applications 55 that the medical practice management server 15 can access. In one version, the medical practice management server 15 (and/or the payor server 20) is a member of a server farm, which is a logical group of one or more servers that are administered as a single entity. In the embodiment depicted in FIG. 1, the server farm includes the server 15, a second server 60, and a third server 65 (the latter two shown in shadow). In one embodiment, the medical practice management server is in communication, via the communications network 30, with a fax machine 68 (shown in shadow) or similar device that receives and/or transmits facsimile transmissions. Alternatively, the fax machine 68 can be connected directly to the medical practice management server 15, via, e.g., a serial, parallel and/or Ethernet connection or the like.

In one implementation, a second medical payor server computer (not shown) communicates with the server 15 through the payor server network 40.

Typically, the medical practice client 10 is used by a medical care provider. Examples of the medical care provider include, but are not limited to, medical physicians, medically trained individuals, medical specialists, medical experts, receptionists, and the like. The medical practice client 10 is typically located in a medical practice. In one embodiment, the medical practice is the office of the medical care provider (e.g., a doctor's office), a hospital, other facilities providing medical treatment, and the like. Further, in one embodiment, a payor organization, or payor, uses the payor server 20. Although also referred to below as an insurance company, example embodiments of a payor organization also include, but are not limited to, health maintenance organizations (HMOs). More specifically, examples of payor organizations include, without limitation, Century Health and Benefits, HMO Blue, Harvard Pilgrim Health Care, MassHealth, Medicare, Neighborhood Health Plan, Tufts Associated Health Plan, United Healthcare, and the like.

Beneficially, many medical practices may utilize the same medical practice server 15 via medical practice clients 10 located at the respective medical practice locations. In some implementations providing service for multiple medical practices is achieved by providing data storage (not shown), e.g., databases and/or database tables, file systems, and the like, for each practice. For example, Dr. Smith, an internist, may utilize the medical practice management system 5 and Dr. Jones, an oral surgeon, who is not affiliated or associated with Dr. Smith, may also use the medical practice management system 5. Information associated with Dr. Smith's practice is stored in one practice database, while information associated with Dr. Jones' practice is stored in another database. In some implementations, there is one database and the information associated with the respective doctors' practice is stored in separate tables. In other implementations the information associated with the respective doctors' practices is stored as different rows in the same database table.

Providing the system 5 to multiple practices is mutually advantageous to the participating medical practices and the implementer of the system 5. The medical practices can communicate between each other via the server 15 and can modify the patient workflow of a patient common to each practice. Continuing the previous example, by both using the medical practice management system 5, Doctors Smith and Jones may easily refer patients between themselves, or approve procedures recommended by the other, etc. The system 5 is benefited because configuring the server 15 to interact with a payor for one medical provider obviates the need to configure the server 15 to interact with the payor for a second provider because the configuration is already done. Continuing the prior example, if in configuring the system 5 for Dr. Smith's practice, the medical practice management system 5 was configured to interact with Blue Cross/Blue Shield of Massachusetts (BCBSMA), if Dr. Jones also accepts BCBSMA, the system 5 does not need to be configured a second time. Rather, when configuring the server 15 for Dr. Jones' practice, only that Dr. Jones accepts BCBSMA need be provided. Beneficially, the more medical practices that use the same payor, the greater the return on investment in initially configuring the medical payor.

Additionally or alternatively, in some implementations, the medical practice management system 5 is operated as a subscription-based model, with pricing and/or support levels determined by a contract between the medical practice and the implementer and/or operator of the medical practice server 15. Some embodiments provide the full functionality of the system 5, while other embodiments provide only limited functionality to certain medical practices, e.g., only batch processing of claims instead of real-time claim processing, twenty four-hour daily support versus sixteen hour, five days a week support, or other functional limitations. In some embodiments, only a small amount of functionality is provided to those medical practices that do not subscribe to the medical practice management system service. Medical practices that subscribe to the service are typically referred to as “group practices.” Medical practices that do not subscribe to the service are usually referred to as “non-group practices.” Non-group practices may, for example, see patient records upon approval but cannot affect the patient workflow, or, where messaging capabilities are provided (described herein) the medical practice may leave messages for group practices. Other versions of the system provide mixed levels of service, or provide different levels of service to both group and non-group medical practices that are using the system 5, e.g., in some versions non-group practices make changes to a patient workflow.

Referring to FIG. 2A, the medical practice management server 15 includes a workflow processing engine 70, a rules engine 75, and an intelligent transactions relationship (ITR) module 80. In one embodiment, the rules engine 75 includes a rules database interface 85 and a rules database 90. In one embodiment, the workflow processing engine 70, the rules engine 75 and/or the ITR module 80 are software modules located within the medical practice management server 15. In another embodiment, one or more of the engines 70, 75 and/or the ITR module 80 are externally located from the server 15 and communicate with the server 15.

In one embodiment, the workflow processing engine 70 is a software application that controls and manages the features and functions of the medical practice management system 5. The workflow processing engine 70 and the medical practice client 10 communicate over the medical practice client-server network 30. In operation, the medical practice client 10 transmits a medical care provider request containing information to the medical practice management server 15 using, for example, a common gateway interface (CGI) request. For example, when registering a new patient, a medical care provider operating the medical practice client 15 enters the relevant patient information on a patient registration template that the workflow processing engine 70 delivered to the medical practice client user interface 45.

The workflow processing engine 70 also checks the structure and composition of information entered by a medical care provider at the medical practice client 10 to ensure that the information is correct (i.e., structure and/or composition). Examples of information entered by a medical care provider at the medical practice client 10 include the patient's address, phone number, medical history, insurance information, diagnosis and procedure codes, and the like.

The workflow processing engine 70 is additionally in communication with the rules engine 75. The rules engine 75 enables real-time application of “rules” stored in the rules database 90. A rule is coded logic that evaluates data and then performs an action.

The rules engine 75 can access and update information stored in the rules database 90 using the rules database interface 85. Although not shown in FIG. 2, in another embodiment the rules database interface 85 is a software layer internal to the workflow processing engine 70. Typically, the rules database interface 85 is implemented as an application program interface, a Component Object Model (COM) object, an Enterprise Java Bean, or the like.

The rules database 90 and/or the rules database interface 85 may be written in a structured query language, such as SQL. In one embodiment, the rules database interface 85 uses a Lightweight Directory Access Protocol (LDAP) to access information in the rules database 90. Additionally or alternatively, the rules database 90 can be external to the server 15 or may be internally situated in the server 15.

The rules database 90 includes insurance company rules that define the appropriate format and content of clinical and claim information that the payor server 20 processes. In one embodiment, the rules are subdivided into various classes. For example, the rules are divided into rules that have universal applicability to all claims for a specified payor, rules that apply only to one or more specific insurance packages from among the variety of insurance packages that the payor offers to medical care providers, and rules that apply only to specific medical care providers who provide care under one or more specific insurance packages.

Typically, a trigger invokes the application of a particular rule. For example, the submission of an insurance claim for a first payor could invoke the rules engine 75 to apply particular formatting rules associated with the first payor to format the claim to the first payor's specification. Typically rules are checked and applied in real-time.

To ensure that the rules database 90 contains current rules, the rules database 90 is frequently updated. In one embodiment, individual payors transmit rule updates/creations to the medical practice management server 15 via their payor server 20. Rule specialists review the rules transmitted by the payor server 20 and subsequently update the rules database 90. In one embodiment, the rules specialist performs any and all updates to the rules database 90. Alternatively, the updating of the rules database 90 can be automated upon receipt of a rule transmission from the payor server 20 or the medical practice client 10.

Additionally, a medical care provider can submit information to the medical practice management server 15 for subsequent update of the rules database 90 based on the medical care provider's experience with one or more payors. In another embodiment, the rules database 90 is updated with the server's historical analysis of previously submitted claims, especially those that were denied, to identify the reasons for denial. The historical analysis of previously submitted claims can facilitate the development of new rules for the rules database 90.

Referring to FIG. 2B, the rules engine 75 may interact with several payors (and therefore several payor servers 20), such as a first payor 95, a second payor 100, and a third payor 105. The rules engine 75 receives information 110, such as an insurance claim, from the workflow processing engine 70. In one embodiment, the rules engine 75 determines the payor 95, 100, 105 that the information 110 will be submitted by, for instance, searching the information 110 for a payor field. Once the rules engine 75 determines the receiving payor 95, 100, 105, the rules engine 75 applies the appropriate rules that are stored in the rules database 90 for the particular payor 95, 100, 105 to the information 110.

For example, the rules engine 75 applies the rules to the information 110 for the first payor 95 and subsequently transforms the originally received information 110 into first information 110′ having a form acceptable to the first payor 95. Likewise, the rules engine 75 applies the rules to the information 110 for the second payor 100 and subsequently transforms the originally received information 110 into second information 110″ having a form acceptable to the second payor 100. The rules engine 75 performs the same process to the information 110 to format the information 110 into third information 110′″ acceptable to the third payor 105.

Referring again to FIG. 2A, in one embodiment the medical practice management server 15 also includes a patient information database 115 (shown in shadow) and an insurance information database 120 (shown in shadow). The workflow processing engine 70 stores all of the information associated with a registered patient in the patient information database 115. The patient information database 115 stores information associated with existing patients of the medical practice. The information can include, for example, the patient's address, phone number, zip code, height, weight, allergies, previous doctor(s), and the like. In one embodiment, the medical practice management server 15 indexes the patient information stored in the patient information database 115 by the patient name. In another embodiment, the server 15 indexes the patient information stored in the patient information database 115 with a patient identifier. The patient identifier can be a random number, a predetermined integer (such as a patient counter), the patient's zip code, the patient's phone number, and the like. The workflow processing engine 70 typically accesses the patient information database 115 using a patient information database interface 125.

Similarly, the workflow processing engine 70 can store all of the information associated with an insurance company in the insurance information database 120, such as the insurance company's address, the amount of insurance coverage for a particular patient, and the like. Moreover, the workflow processing engine 70 can access the insurance information database 120 using an insurance information database interface 130.

In operation, as the workflow processing engine 70 receives information from the medical practice client 10, the workflow processing engine 70 determines on a real time basis whether all of the required information has been provided and whether the information is in the correct format. In the event that there is a deficiency in the information, the workflow processing engine 70 alerts the medical care provider (e.g., receptionist), or user, for additional information. Alternatively, the workflow processing engine 70 corrects the defect.

For instance, if the rules engine 75 contains a rule about member identification formatting for a particular payor, the rules engine 75 determines the rule in the rules database 90 and communicates the information to the workflow processing engine 70. The workflow processing engine 70 communicates this information to the medical practice client 10 when a medical care provider (e.g., receptionist) is registering a patient. If the medical care provider (e.g., receptionist) errs, the medical practice management server 15 alerts the medical care provider (e.g., with a warning message) to correct the error. This enables medical care providers to generate claims with no errors (i.e., referred to as clean claims) for the mutual benefit of the medical care provider and the payor. Additionally, the medical care providers can obtain the information associated with an alert while the patient is physically present, e.g., while the patient is still at the hospital or medical service provider during their procedure or before checking out.

The workflow processing engine 70 is also in communication with the ITR module 80. The ITR module 80 executes transactions sent to and received from the payor server 20. Thus, the majority of provider/payor transactions can be accomplished electronically, with little or no human intervention. Examples of these transactions include, without limitation, claim submittals, claim receipt acknowledgements, claim status checks, patient eligibility determinations, authorization and referral requests and grants, and remittance advice. For example, a predetermined number of days before a scheduled patient visit, the ITR module 80 automatically checks patient eligibility with the applicable payor identified during the patient registration process. After a patient visit and the completion of the claim template, the claim is submitted to the payor server 20 via the ITR module 80.

In one embodiment, upon receipt of an insurance claim, the payor 20 transmits a confirmation back to the medical practice management server 15. Later, on a schedule determined by the medical care provider, the ITR module 80 checks the claim status and notifies the medical practice client 10 accordingly. After the ITR module 80 analyzes the claim and generates remittance advice, the ITR module 80 parses the electronic payment and allocates the payment among the individual charge line items for the services provided. Once the medical care provider approves the allocations, the payments are posted to the provider's accounts.

Although described above as individual components, the engines 70, 75 and the ITR module 80 can be combined into one component or any number of components. Similarly, the databases, 90, 115, 120 could also be combined into one database and can be external or internal to the server 15. In other embodiments, the patient information and/or the insurance information is stored on a disk, such as a compact disk or a ZipDrive, developed by Iomega Corporation (Roy, Utah).

Incorporating new technology into an existing medical practice is often difficult. Documents associated with a patient, for example, a patient's medical charts, are typically provided physically, i.e., as “hard copies,” when a patient is being serviced by multiple health care providers, e.g., after being referred to a specialist by a primary care physician, or when a hospital receives a patient's charts from a family doctor. In some cases, a patient's documents, charts, and medical history are stored electronically by a healthcare provider. These documents can then be printed out and mailed to another healthcare provider if necessary. Typically if charts, e.g., images or faxes, are stored electronically they are generally stored as originally received, i.e., unaltered.

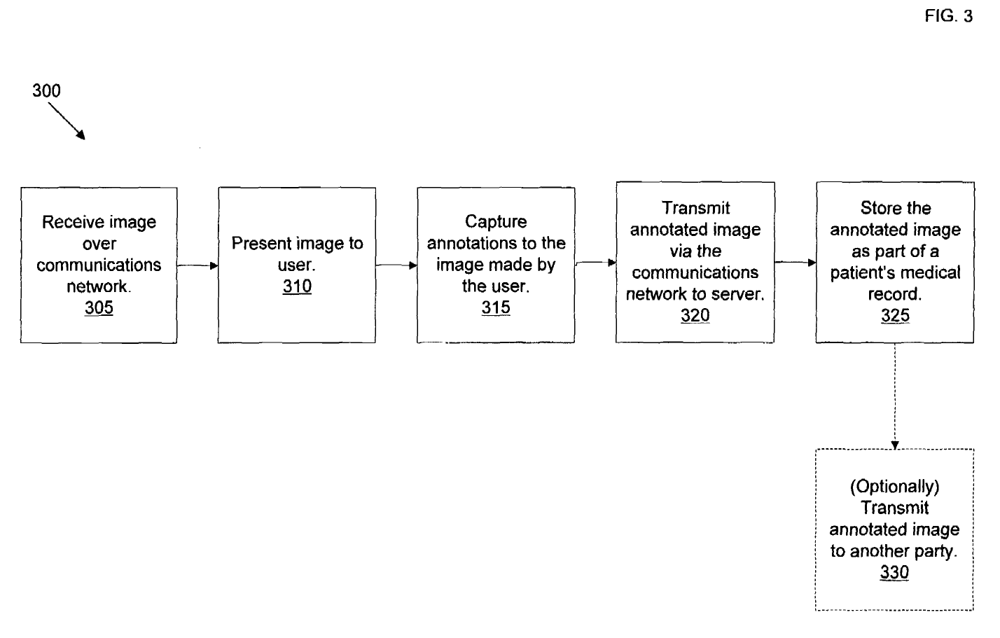

FIG. 3 is a block diagram depicting a method 300 for electronically annotating an image associated with a patient workflow. The image is typically an image such as an X-ray or a Magnetic Resonance Image (MRI), though the image may be any chart or document associated with the patient's medical records. Additionally or alternatively, the image could be a contract between providers, an approval by a doctor for a treatment plan, or a doctor's prescription for a patient that is viewable by a pharmacist. In some embodiments, the image is a consent or waiver form that a patient needs to sign. In some of these embodiments, a kiosk located in the medical care provider's facility serves as the medical practice client 10 and a patient interacts with the system 5 or the server 15 via the screen of the kiosk. Alternatively, the medical practice client 10 may be embodied as a web browser that has access to a web portal, the web portal providing access to the medical practice management system 5 or the medical practice management server 15. The patient accesses the portal from outside the medical care provider's office, e.g., accessed from the patient's home computer. In these embodiments, e.g., the kiosk or the web portal, patients can electronically sign consent forms or waiver forms through the annotation process. Allowing patients to access the system and sign consent and waiver forms makes treatment procedures more efficient because a patient no longer needs to be physically at the medical provider's location to sign necessary documents, nor do they have to wait to receive the documents in the postal mail, sign them, and mail them back to the medical care provider facility. Advantageously, annotations made to the image are able to be used, e.g., for treatment authorizations, legally, and the like, as if the markings were made to the original document.

The image is received 305 by the medical practice management server 15 via a communications network 30. In some versions the image is received by the medical practice management server 15 via a LAN, MAN, WAN, the Internet, over a phone line, or the like. In other embodiments the image is received via a facsimile machine 68 in communication with the medical practice management server 15. In some embodiments the image is communicated by the fax machine via the communications network 30. In other embodiments the image is communicated to the medical practice management server via a direct data connection, e.g., Ethernet cable, or parallel or serial connection. Additionally or alternatively, the medical practice management system 5, in some versions, employs software that converts a received facsimile into an image file. The software, in some embodiments, is executed on the medical practice management server 15. In other embodiments the software executes on a server (not shown) that is signally located on the communications network 30 between the fax machine and the medical practice management server 15. In any of these scenarios, the image may be received and/or stored in virtually any format, e.g., a CompuServe's Graphics Interchange Format file (GIF), a file of the type defined by the Joint Photographic Experts Group (JPEG), a Tagged Image File Format file (TIFF), a Portable Network Graphic file (PNG) or the like. The image is then presented 310 to a user, the user usually being a medical care provider such as a doctor or nurse or staff member at a medical care provider location, e.g., a receptionist. Typically the image is presented to the user via a web browser, the web browser usually executed on a medical practice client 10.

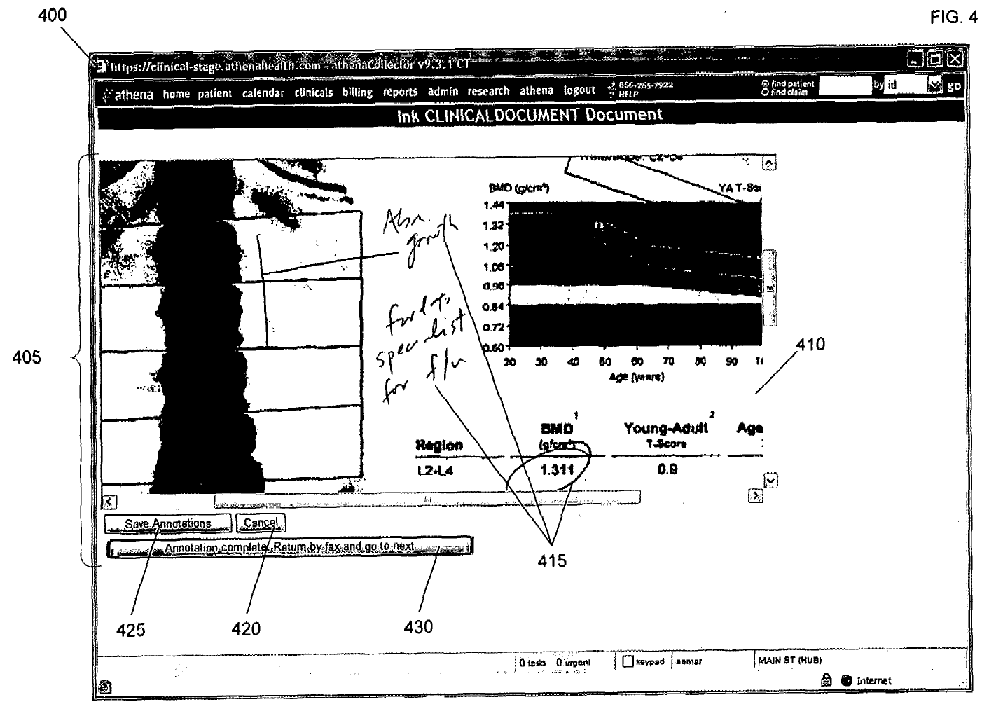

Referring now to FIG. 4, in some implementations a web browser 400 includes a plug-in 405 to present the image 410 to the user. In some versions the plug-in 405 utilizes an ActiveX control to present the image to the user and to provide means for the user to interact with the image and annotate it. Beneficially, the plug-in 405 allows for input from the user e.g., annotations 415 to the image, via a web browser even though the web-browser does not natively support revisions to an image. These annotations 415 are often text typed by the user using a keyboard or are drawn in/on the plug-in 405 by the user using a mouse or other pointing device, e.g., a digital pen. Annotations 415 made to the image are captured (315 of FIG. 3) by the plug-in. In some implementations, the annotations are converted from a format native to the ActiveX plug-in to a layer format native to the image. Beneficially, converting the annotations to a layer format allows any software able to view the image to also view the annotations (whereas without the conversion, the ActiveX plug-in would be required to view the annotations). In some versions the annotations are stored in memory allocated to the plug-in on the client. In other versions, the annotations are submitted to the medical practice server and stored in memory on the medical practice management server. In either scenario, annotations are temporarily stored in memory and allow for editing functions such as undo, erase, redo, and the like, allowing the user to revise the annotations before the annotations are final. Typically the plug-in 405 also presents inputs, e.g., buttons, for a user to cancel the annotation process 420, save the annotations 425, and/or complete the annotations and send the annotations back to the original sender 430. Canceling the annotation process does not transmit the annotations made during the session, effectively undoing any work that was performed during the current annotation session. Functions such as saving annotations and return by fax are described below.

Referring back to FIG. 3, once the user is done annotating the image, for example, by clicking “save annotations” (420 of FIG. 4), the annotations and the image are transmitted 320 from the medical practice client 10 over the communications network 30 to the medical practice management server 15. Once received, the image and the annotations are stored 325 as part of a patient's medical record and are viewable by medical care providers that have access to the patient's medical records. Beneficially, in some embodiments, the annotations are stored separately from the image and the annotations, the image, and/or both are only viewable by medical providers that are allowed access via authentication software logic, e.g., to comply with patient privacy standards such as the Health Insurance Portability and Accountability Act of 1996 (HIPAA) and the implementing regulations thereof. For example, the medical practice management server 15 would not provide a podiatrist access to a patient's pulmonary MRIs because a podiatrist, a specialist in feet, has no need, without the patient's consent, to view exams and information related to the patient's lungs. Advantageously, once annotations are stored 325, another annotation session may be initiated by the user and a second set of annotations may be made. In some embodiments the new annotations are combined with the annotations previously made by this user, storing all annotations made by this user as one set of annotations. In other embodiments the annotations are stored separately according to browser session or to when the last time a “save annotations” button 420 was clicked or similar input was received. Saving multiple annotations per user is beneficial in that a user may make incremental annotations and cancel or undo annotations made only during the current session or made since the last time the “save annotations” button 420 was clicked.

In some versions, the medical practice management server 15 transmits 330 the annotations and the image to, for example, the original sender of the image or to a third-party, e.g., a payor. The transmission may occur over a different medium than was originally received, e.g., if received via fax, the annotated image may be sent via a LAN, MAN, WAN, the Internet, or the like. Alternatively, the image may be transmitted via the original means, e.g., if the image was received via fax, the medical practice management server 15 transmits the annotated image to the fax machine or fax client the sender used to transmit the image originally. In some embodiments where the third-party is a payor, a payor server 20 may require annotated images for the processing of claims. The ITR module 80 of the medical practice management server 15, before, during, or after submitting a claim, determines if a claim requires an annotated image and if so, submits the image to the payor server 20 via methods described herein. Additionally or alternatively, the medical practice management server 15 receives 305 and/or transmits 320, 330 the images and annotated images via a secure connection, e.g., a secure file transfer protocol (SFTP), secured web browser session, or the like.

In some embodiments, the images and annotations are maintained and transmitted 330 to the sender separately, for example if the original sender utilizes the medical practice management system 5, the medical practice management server 15 (e.g., as part of a medical practice management application service provider subscription model), or a compatible system that has the ability to store the image and annotations separately. Determining if the sender has the capability to receive and/or maintain the image and the annotations separately is typically done via software logic on the medical practice management server 15, e.g., determining that the sender also is a user of the medical practice management system 5. If the original sender is not a user of the medical practice management system 5, determining if the original sender can receive the image and annotations separately is typically accomplished via negotiations between the user/medical care provider and the original sender.

Alternatively, the image and annotations, if stored separately, may be combined and “flattened” together into one image, e.g., the original image with the annotations overlaid, and the combination transmitted to the original sender or third-party. Combining the image and annotations before sending is advantageous for scenarios where the original sender used technology, such as a fax machine, that does not support image layers. In that scenario, the sender of the original image transmitted a fax of a patient's chart to the user and the original sender receives a fax back with the annotated image. The original sender may then incorporate the annotated image into their patient workflow and document storage system, whether their patient workflow and document storage system is electronic or paper-based.

In some embodiments, the annotations are submitted as part of a medical patient workflow. For example, a primary care physician may have a question about a patient's X-ray and wants the opinion of a specialist. The primary care physician submits the request for clarification to the medical practice management server 15 and transmits the X-ray to the specialist, via, e.g., fax, e-mail, or as an image served by the medical practice management server 15. A workflow task is created for the request on the medical practice management server 15 and a notification is sent to the specialist. The request for clarification appears as part of a task list viewable by the specialist (via a medical practice client 10). The specialist then annotates the image using the techniques described herein and submits the response and the annotations to the medical practice management server 15. A notification is sent to the primary care physician that the specialist responded and the annotations and the X-ray are provided to the primary care physician. Additionally, multiple users can review and revise the annotations of others, and multiple users can make multiple annotations to the same image. Advantageously, annotating the image, rather than utilizing a proprietary annotation format, allows a medical care provider to send the annotated image to a medical provider that uses a different medical practice management software package to view the annotated image.

The annotations to the image are captured in several ways. The software for capturing annotations typically provides brushes, color palettes, shapes, and erasing functionality for users to make annotations in different shapes, colors, to create uniform circles, rectangles, etc, and to erase or undo prior annotations, respectively. In some embodiments, capturing involves receiving an electronic signal corresponding to a location of a pixel of the image. As an example, in one version, an X-ray is represented as a 1024×768 image. A pixel of that image located at the 500^{th} horizontal position and the 200^{th} vertical position, i.e., x/y coordinates 500, 200, may be white and represents a piece of bone. In one embodiment an annotation made to the image captures that the user moved the pointing device as part of an annotation over the 500, 200 pixel. The pixel locations that the user moved the pointing device over are stored as the annotation yet no changes are made to the actual image. In some versions, the annotation involves editing the image itself, e.g., changing the color of the pixels that make up the image. Using the prior example, moving the pointing device over the 500, 200 pixel changes the pixel color from white to red, e.g., as if the user wrote directly on the X-ray image using a red pen. As stated herein, the color of annotations is user-selectable using a palette provided by the plug-in.

In some embodiments, rather than change the image directly, an annotation is captured in a second layer or overlay. For example, rather than changing the 500, 200 pixel from white to red, in some implementations a second 1024×768 layer is created and the 500, 200 pixel of the second layer is made red. Where the image type supports layers, the second layer may be part of the image itself and may be transmitted to and/or stored on the medical practice management server 15. This allows the annotation to be present when the image is viewed, but may be hidden when so desired, i.e., by viewing software that allows the user to hide or show different layers of an image. Where multiple users have annotated the image, each annotation is preserved in a separate layer. Alternatively, in some versions, the layer is a separate electronic image that is transmitted and/or stored on the medical practice management server 15.

Where the image type does not support layers, the software creates a virtual layer, e.g., a layer in memory representing a 1024×768 layer, and allow for the “flattening” of the image and the second layer into one layer, wherein the second layer is imposed on the first layer, effectively overlaying the annotations onto the image. Beneficially, the annotations are stored as part of a medical patient's record and are viewable by anyone authorized to view the patient's records, e.g., doctors, nurses, or insurance companies.

The above-described techniques can be implemented in digital electronic circuitry, or in computer hardware, firmware, software, or in combinations of them. The implementation can be as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer also includes, or is operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. The alternatives described herein are examples for illustration only and not to limit the alternatives in any way. The steps of the invention can be performed in a different order and still achieve desirable results. Other embodiments are within the scope of the following claims.

What is claimed is:

1. A method for electronically annotating an image associated with a medical patient workflow comprising:
receiving the image via a communications network;
presenting the image to a user associated with the patient workflow;
capturing an annotation made to the image by the user;
transmitting the annotated image via the communications network to a medical practice management server; and
storing the annotated image as part of a patient medical record.

2. The method of claim 1 wherein presenting comprises loading the image in a web browser.

3. The method of claim 1 further comprising submitting the annotated image to the medical patient workflow.

4. The method of claim 1 wherein the network comprises a facsimile (fax) machine.

5. The method of claim 1 wherein capturing comprises receiving an electronic signal corresponding to a location of a pixel of the image.

6. The method of claim 1 wherein the annotation comprises an edit to the image.

7. The method of claim 6 wherein the edit comprises a keystroke received from a keyboard.

8. The method of claim 6 wherein the edit comprises a movement received from a pointing device.

9. The method of claim 8 wherein the pointing device comprises a digital pen.

10. The method of claim 8 wherein the pointing device comprises a mouse.

11. The method of claim 1 further comprising transmitting the annotated image from the medical practice management server to a second party.

12. The method of claim 11 wherein the second party is who the image was received from.

13. The method of claim 11 wherein the second party is a payor.

14. A computer program product, tangibly embodied in an information carrier, for electronically annotating an image associated with a patient workflow, the computer program product including instructions being operable to cause a data processing apparatus to:
receive the image via a communications network;
present the image to a user associated with the patient workflow;
capture an annotation made to the image by the user;
transmit the annotated image via the communications network to a medical practice management server; and
store the annotated image as part of a patient medical record.

15. The computer program product of claim 14 further including instructions operable to cause a data processing apparatus to submit the annotated image to the medical patient workflow.

16. The computer program product of claim 14 wherein the network comprises a facsimile (fax) machine.

17. A system for electronically annotating an image associated with a patient workflow comprising:
a server configured to receive the image and transmit the image over a communications network;
a client software program configured to receive the image from the server, and further configured to capture an annotation to the image made by a user, and further configured to transmit the image and the annotation to the image to the server; and
wherein the server is further configured to store the image as part of a medical patient medical record.

18. The system of claim 17 wherein the client software program comprises a web browser.

19. The system of claim 18 further comprising a plug-in to the web browser.

20. The system of claim 17 wherein the communications network comprises a facsimile machine.
